(19) United States
(12) Patent Application Publication
(10) Pub. No.: US 2022/0100169 A1
(43) Pub. Date: Mar. 31, 2022

(54) METHOD OF GENERATING THREE-DIMENSIONAL SHAPING DATA AND METHOD OF MANUFACTURING THREE-DIMENSIONAL SHAPED OBJECT

(71) Applicant: SEIKO EPSON CORPORATION, Tokyo (JP)

(72) Inventor: Ryusuke TAKAKURA, Matsumoto (JP)

(21) Appl. No.: 17/486,967

(22) Filed: Sep. 28, 2021

(30) Foreign Application Priority Data
Sep. 30, 2020 (JP) 2020-164759

(51) Int. Cl. G05B 19/4099; B33Y 50/00; B29C 64/386

(52) U.S. Cl. CPC G05B 19/4099; G05B 2219/35134; B29C 64/386; B33Y 50/00

(57) ABSTRACT

A method of generating three-dimensional shaping data includes: a first step of acquiring first shape data representing a shape of a three-dimensional shaped object; a second step of accessing a database and inquiring whether second shape data corresponding to the first shape data is stored in the database; and a third step of acquiring or generating the three-dimensional shaping data for shaping the three-dimensional shaped object in accordance with an inquiry result in the second step. In the third step, when the second shape data is stored in the database, second shaping data associated with the second shape data is acquired from the database as the three-dimensional shaping data, or the three-dimensional shaping data is generated using related data related to the second shaping data, and when the second shape data is not stored in the database, first shaping data is generated using the first shape data as the three-dimensional shaping data.

The present application is based on, and claims priority from JP Application Serial Number 2020-164759, filed Sep. 30, 2020, the disclosure of which is hereby incorporated by reference herein in its entirety.

### BACKGROUND

### 1. Technical Field

The present disclosure relates to a method of generating three-dimensional shaping data and a method of manufacturing a three-dimensional shaped object.

### 2. Related Art

JP-A-2017-077671 discloses a method of repeatedly performing simulation while changing shaping conditions such as a lamination method, a material, and a lamination pitch to obtain a shaping condition in which warpage deformation or residual stress of a three-dimensional shaped object falls within an allowable range, and then shaping a three-dimensional shaped object under the shaping condition in which the warpage deformation or the residual stress falls within the allowable range.

In the method described above, since three-dimensional shaping data is generated after the simulation is executed and it is confirmed that the warpage deformation or the residual stress of the three-dimensional shaped object falls within the allowable range, a large amount of time may be taken to generate the three-dimensional shaping data.

### SUMMARY

According to a first aspect of the present disclosure, a method of generating shaping data for shaping a three-dimensional shaped object is provided. The method of generating shaping data includes: a first step of acquiring first shape data representing a shape of the three-dimensional shaped object; a second step of accessing a database storing a plurality of pieces of shape data representing a shape of an object and a plurality of pieces of shaping data generated using the plurality of pieces of shape data in association with each other, and inquiring whether second shape data, which is the shape data corresponding to the first shape data, is stored in the database; and a third step of acquiring or generating the three-dimensional shaping data for shaping the three-dimensional shaped object in accordance with an inquiry result in the second step. In the third step, when the second shape data is stored in the database, second shaping data, which is the shaping data associated with the second shape data, is acquired from the database as the three-dimensional shaping data, or the three-dimensional shaping data is generated using related data related to the second shaping data, and when the second shape data is not stored in the database, first shaping data is generated using the first shape data as the three-dimensional shaping data.

According to a second aspect of the present disclosure, a method of manufacturing a three-dimensional shaped object is provided. The method of manufacturing a three-dimensional shaped object includes: a first step of acquiring first shape data representing a shape of the three-dimensional shaped object; a second step of accessing a database storing a plurality of pieces of shape data representing a shape of an object and a plurality of pieces of shaping data generated using the plurality of pieces of shape data in association with each other, and inquiring whether second shape data, which is the shape data corresponding to the first shape data, is stored in the database; a third step of acquiring or generating the three-dimensional shaping data for shaping the three-dimensional shaped object in accordance with an inquiry result in the second step; and a fourth step of shaping the three-dimensional shaped object using the three-dimensional shaping data. In the third step, when the second shape data is stored in the database, second shaping data, which is the shaping data associated with the second shape data, is acquired from the database as the three-dimensional shaping data, or the three-dimensional shaping data is generated using related data related to the second shaping data, and when the second shape data is not stored in the database, first shaping data is generated using the first shape data as the three-dimensional shaping data.

### BRIEF DESCRIPTION OF THE DRAWINGS

FIG. 1 is an explanatory diagram showing a schematic configuration of a three-dimensional shaping system according to a first embodiment.

FIG. 2 is a cross-sectional view showing a schematic configuration of a three-dimensional shaping device according to the first embodiment.

FIG. 3 is a perspective view showing a configuration of a flat screw.

FIG. 4 is a top view showing a configuration of a barrel.

FIG. 5 is an explanatory diagram showing a configuration of a control unit according to the first embodiment.

FIG. 6 is an explanatory diagram showing an example of shape data.

FIG. 7 is an explanatory diagram showing an example of slice data.

FIG. 8 is an explanatory diagram showing an example of tool path data.

FIG. 9 is an explanatory diagram showing an example of analysis result data.

FIG. 10 is an explanatory diagram showing an example of shaping data.

FIG. 11 is a flowchart showing contents of three-dimensional shaping processing according to the first embodiment.

FIG. 12 is a flowchart showing contents of shaping data generation processing according to the first embodiment.

FIG. 13 is an explanatory diagram schematically showing a state in which a three-dimensional shaped object is shaped.

FIG. 14 is a flowchart showing contents of three-dimensional shaping processing according to a second embodiment.

FIG. 15 is an explanatory diagram showing a schematic configuration of a three-dimensional shaping system according to a third embodiment.

FIG. 16 is a flowchart showing contents of three-dimensional shaping processing according to the third embodiment.

FIG. 17 is an explanatory diagram showing a schematic configuration of a three-dimensional shaping system according to a fourth embodiment.

FIG. 18 is a flowchart showing contents of three-dimensional shaping processing according to the fourth embodiment.

FIG. 19 is an explanatory diagram showing a schematic configuration of a three-dimensional shaping system according to a fifth embodiment.

### DESCRIPTION OF EXEMPLARY EMBODIMENTS

### A. First Embodiment

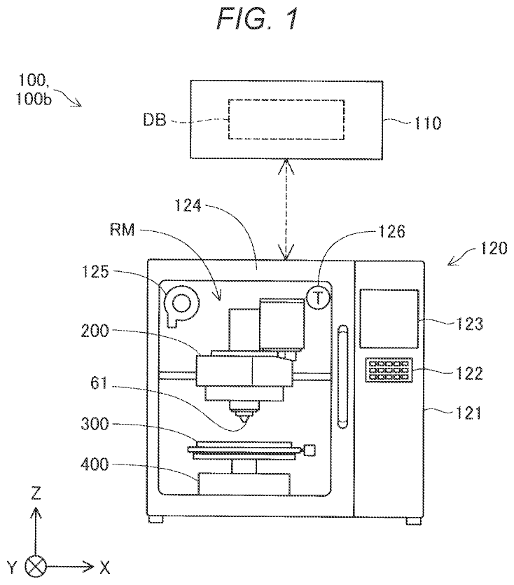

FIG. 1 is an explanatory diagram showing a schematic configuration of a three-dimensional shaping system 100 according to a first embodiment. FIG. 1 shows arrows indicating X, Y, and Z directions orthogonal to one another. The X direction and the Y direction are directions parallel to a horizontal plane. The Z direction is a direction opposite to a gravity direction. The arrows indicating the X, Y, and Z directions are appropriately shown in other figures so that the shown directions correspond to those in FIG. 1. In the following description, when a direction is specified, “+” indicates a positive direction that is a direction indicated by an arrow, “−” indicates a negative direction that is a direction opposite to the direction indicated by an arrow, and positive and negative symbols are used together to indicate directions.

The three-dimensional shaping system 100 according to the present embodiment includes a data storage device 110 that stores various types of data for shaping a three-dimensional shaped object, and a three-dimensional shaping device 120 that shapes the three-dimensional shaped object.

The data storage device 110 is implemented by a hard disk drive. The data storage device 110 may be implemented by a solid state drive or may be implemented by a network-attached storage. The data storage device 110 includes a database DB. In the database DB, shape data such as three-dimensional CAD data or three-dimensional CG data and three-dimensional shaping data for controlling the three-dimensional shaping device 120 to shape the three-dimensional shaped object are stored in association with each other. The database DB stores a plurality of pieces of shape data and a plurality of pieces of three-dimensional shaping data. Each piece of shape data represents a three-dimensional shape of an object. In the following description, the three-dimensional shaping data is referred to as shaping data.

The three-dimensional shaping device 120 includes a housing 121, a shaping unit 200, a stage 300, a position changing unit 400, and a control unit 500. Under control of the control unit 500, the three-dimensional shaping device 120 discharges a shaping material from a nozzle 61 while changing a relative position between the nozzle 61 provided in the shaping unit 200 and the stage 300 by the position changing unit 400, thereby laminating the shaping material on the stage 300 to shape the three-dimensional shaped object. In the present embodiment, the shaping unit 200, the stage 300, and the position changing unit 400 are disposed in a shaping chamber RM provided inside the housing 121.

In the present embodiment, an operation panel 122, a display unit 123, and an opening and closing door 124 are provided on a front surface portion of the housing 121. The operation panel 122 is implemented by, for example, a switch, and receives an operation from a user. The display unit 123 is implemented by, for example, a liquid crystal monitor, and displays various types of information related to the three-dimensional shaping device 120. The opening and closing door 124 is closed to block the shaping chamber RM from the outside. In a state in which the opening and closing door 124 is closed, shaping of the three-dimensional shaped object is executed. By opening the opening and closing door 124, the three-dimensional shaped object can be taken out to the outside. A part of the opening and closing door 124 is made of, for example, glass such that the shaping chamber RM can be visually recognized from the outside.

In the present embodiment, an inner wall surface of the shaping chamber RM and the opening and closing door 124 are preferably formed of a member having a heat insulating property. A shaping chamber heater 125 that raises a temperature of the shaping chamber RM and a thermometer 126 that measures the temperature of the shaping chamber RM are disposed in the shaping chamber RM. The shaping chamber heater 125 is implemented by, for example, a blower that sends out hot air under the control of the control unit 500. The temperature measured by the thermometer 126 is transmitted to the control unit 500. The three-dimensional shaped object is shaped in a state in which the shaping chamber RM is maintained at a predetermined temperature by the shaping chamber heater 125.

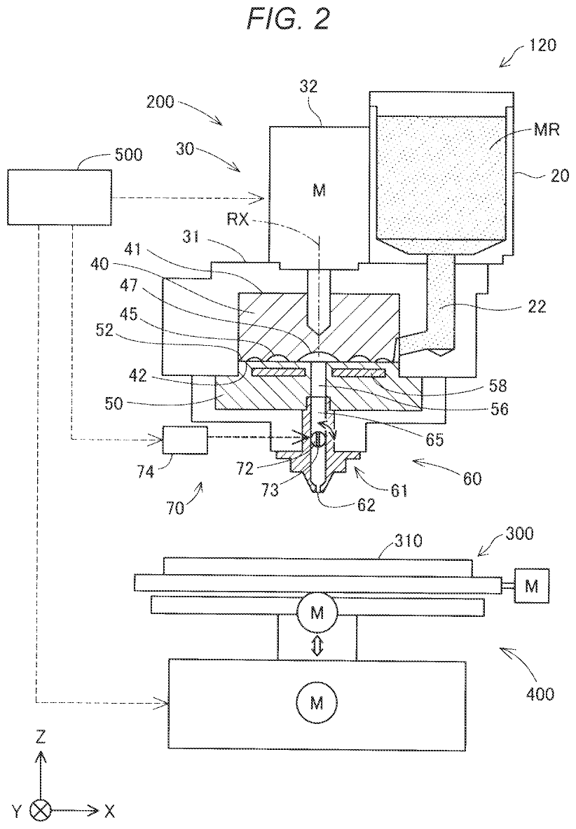

FIG. 2 is a cross-sectional view showing a schematic configuration of the three-dimensional shaping device 120 according to the present embodiment. The shaping unit 200 includes a material supply unit 20 that is a supply source of a material MR, a plasticization unit 30 that plasticizes the material MR into the shaping material, and a discharge unit having the above-described nozzle 61. The term “plasticization” refers to that a thermoplastic material is heated and melted. The term “melt” means not only that the thermoplastic material is heated to a temperature equal to or higher than a melting point to be liquefied, but also that the thermoplastic material is heated to a temperature equal to or higher than a glass transition point to be softened, thereby exhibiting the fluidity.

The material supply unit 20 supplies the material MR for generating the shaping material to the plasticization unit 30. In the present embodiment, the material supply unit 20 is implemented by a hopper that accommodates the material MR. A discharge port is provided below the material supply unit 20. The discharge port is coupled to the plasticization unit 30 via a supply path 22. In the present embodiment, an ABS resin formed in a pellet shape is used as the material MR.

The plasticization unit 30 plasticizes the material MR supplied from the material supply unit 20 via the supply path 22 to form the shaping material, and supplies the shaping material to the discharge unit 60. The plasticization unit 30 includes a screw case 31, a drive motor 32, a flat screw 40, a barrel 50, and a heater 58.

The screw case 31 is a housing that accommodates the flat screw 40. The barrel 50 is fixed to a lower end portion of the screw case 31. The flat screw 40 is accommodated in a space surrounded by the screw case 31 and the barrel 50. The drive motor 32 is fixed to an upper surface of the screw case 31.

The flat screw 40 has a substantially cylindrical shape of which a height in a direction along a central axis RX of the flat screw 40 is smaller than a diameter thereof. The flat screw 40 is disposed in the screw case 31 such that the central axis RX is parallel to the Z direction. The flat screw 40 has a groove forming surface 42 in which a groove portion 45 is formed at a lower end portion facing the barrel 50. The drive motor 32 is coupled to an upper end portion of the flat screw 40 opposite to the groove forming surface 42. The flat screw 40 is rotated about the central axis RX in the screw case 31 by a torque generated by the drive motor 32. The drive motor 32 is driven under the control of the control unit 500.

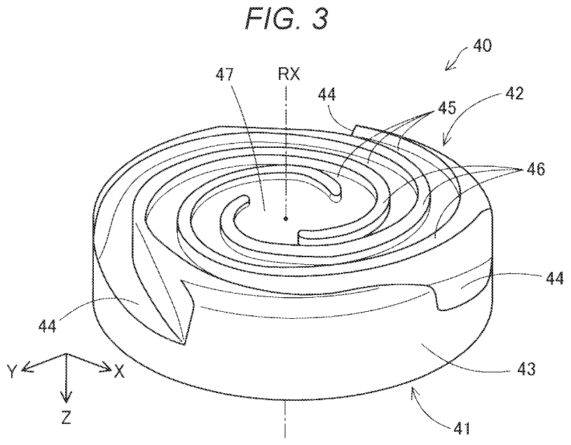

FIG. 3 is a perspective view showing a configuration of the flat screw 40 according to the present embodiment. In FIG. 3, the flat screw 40 is shown upside down from that of FIG. 2 so as to facilitate understanding of the technique. In FIG. 3, a position of the central axis RX of the flat screw 40 is shown by a dashed line.

A central portion 47 of the groove forming surface 42 of the flat screw 40 intersecting the central axis RX is formed as a recess to which one end of the groove portion 45 is coupled. The central portion 47 faces a communication hole 56 of the barrel 50 shown in FIG. 2.

The groove portions 45 extend spirally from the central portion 47 toward an outer periphery of the flat screw 40 so as to draw an arc. The groove portions 45 may be formed in an involute curve shape or may be formed to extend in a spiral shape. The groove forming surface 42 is provided with ridge portions 46 that constitute side wall portions of the groove portions 45 and extend along the groove portions 45. The groove portions 45 are continuous up to material introduction ports 44 formed on a side surface 43 of the flat screw 40. The material introduction port 44 is a portion that receives the material MR supplied via the supply path 22 of the material supply unit 20. The material MR introduced from the material introduction ports 44 into the groove portions 45 is transported toward the central portion 47 in the groove portion 45 by rotation of the flat screw 40.

FIG. 3 shows the flat screw 40 having three groove portions 45 and three ridge portions 46. The number of the groove portions 45 and the ridge portions 46 provided at the flat screw 40 is not limited to three. The flat screw 40 may be provided with only one groove portion 45, or two or more groove portions 45. The number of the ridge portions 46 corresponding to the number of the groove portions 45 may be any number. FIG. 3 shows the flat screw 40 in which the material introduction ports 44 are formed at three positions. The number of positions of the material introduction ports 44 provided in the flat screw 40 is not limited to three. The flat screw 40 may be provided with the material introduction port 44 at only one position, or at two or a plurality of positions.

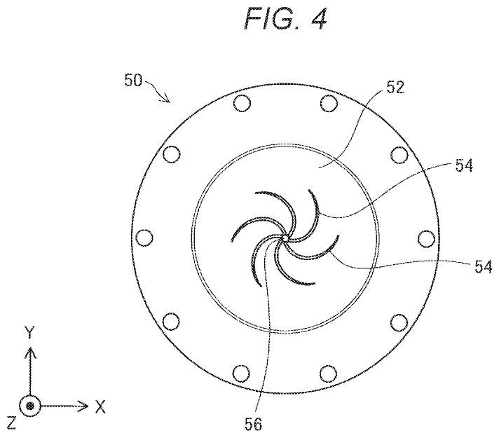

FIG. 4 is a top view showing a configuration of the barrel 50 according to the present embodiment. The barrel 50 has a screw facing surface 52 that faces the groove forming surface 42 of the flat screw 40. The communication hole 56 communicating with the discharge unit 60 is provided on a center of the screw facing surface 52. A plurality of guide grooves 54 are formed in the screw facing surface 52 around the communication hole 56. One end of each guide groove 54 is coupled to the communication hole 56. Each of the guide grooves 54 extends spirally from the communication hole 56 toward an outer periphery of the screw facing surface 52. Each of the guide grooves 54 has a function of guiding the shaping material to the communication hole 56. The screw facing surface 52 may not be provided with the guide groove 54.

As shown in FIG. 2, the heater 58 for heating the material MR is embedded in the barrel 50. In the present embodiment, the heater 58 is supplied with electric power and generates heat. The temperature of the heater 58 is controlled by the control unit 500. The heater 58 may be disposed, for example, below the barrel 50, instead of being embedded in the barrel 50.

The material MR transported in the groove portion 45 is plasticized by shearing due to the rotation of the flat screw 40 and the heat from the heater 58, and becomes a paste-like shaping material. The shaping material is supplied from the communication hole 56 to the discharge unit 60.

The discharge unit 60 is provided below the barrel 50. The discharge unit 60 includes the nozzle 61, a flow path 65, and a discharge amount adjustment unit 70. A nozzle hole 62 is provided at a lower end portion of the nozzle 61. The nozzle 61 discharges the shaping material supplied from the plasticization unit 30 in a −Z direction through the nozzle hole 62. In the present embodiment, the nozzle 61 is provided with the nozzle hole 62 having a circular opening shape. A diameter of the nozzle hole 62 is referred to as a nozzle diameter. The opening shape of the nozzle hole 62 may not be circular, and may be, for example, an elliptical shape or a polygonal shape such as a square shape. The nozzle hole 62 communicates with the communication hole 56 of the barrel 50 via the flow path 65.

The discharge amount adjustment unit 70 adjusts an amount of the shaping material discharged from the nozzle 61. In the following description, the amount of the shaping material discharged from the nozzle 61 is referred to as a discharge amount. In the present embodiment, the discharge amount adjustment unit 70 is implemented by a butterfly valve. The discharge amount adjustment unit 70 includes a drive shaft 72 which is a shaft-like member, a valve body 73 that opens or closes the flow path 65 in accordance with rotation of the drive shaft 72, and a valve drive unit 74 that rotates the drive shaft 72.

The drive shaft 72 is attached in an intermediate portion of the flow path 65 so as to intersect a flow direction of the shaping material. In the present embodiment, the drive shaft 72 is attached so as to be parallel to the Y direction which is a direction perpendicular to the flow direction of the shaping material in the flow path 65. The drive shaft 72 is rotatable about a central axis along the Y direction.

The valve body 73 is a plate-shaped member that rotates in the flow path 65. In the present embodiment, the valve body 73 is formed by processing a portion of the drive shaft 72 provided in the flow path 65 into a plate shape. A shape of the valve body 73 when viewed from a direction perpendicular to a plate surface of the valve body 73 is substantially the same as an opening shape of the flow path 65 at a portion of the flow path 65 where the valve body 73 is provided.

The valve drive unit 74 causes the drive shaft 72 to rotate under the control of the control unit 500. The valve drive unit 74 is implemented by, for example, a stepping motor. The rotation of the drive shaft 72 causes the valve body 73 to rotate in the flow path 65.

When the plate surface of the valve body 73 is held perpendicular to the flow direction of the shaping material in the flow path 65, the supply of the shaping material from the flow path 65 to the nozzle 61 is blocked, and thus the discharge of the shaping material from the nozzle 61 is stopped. When the drive shaft 72 is rotated by the valve drive unit 74 and the plate surface of the valve body 73 is held at an acute angle with respect to the flow direction of the shaping material in the flow path 65, the supply of the shaping material from the flow path 65 to the nozzle 61 is started, and the shaping material is discharged from the nozzle 61 at a discharge amount corresponding to a rotation angle of the valve body 73. As shown in FIG. 2, when the plate surface of the valve body 73 is held parallel to the flow direction of the shaping material in the flow path 65, the flow path 65 is in a most open state. In this state, the discharge amount is maximized. In this manner, the discharge amount adjustment unit 70 can switch ON/OFF of the discharge of the shaping material and implement the adjustment of the discharge amount.

The stage 300 has a shaping surface 310 facing the nozzle 61. A three-dimensional shaped object is formed on the shaping surface 310. In the present embodiment, the shaping surface 310 is parallel to a horizontal direction. The stage 300 is supported by the position changing unit 400.

The position changing unit 400 changes a relative position between the nozzle 61 and the shaping surface 310. In the present embodiment, the position changing unit 400 changes the relative position between the nozzle 61 and the shaping surface 310 by moving the stage 300. The position changing unit 400 according to the present embodiment is implemented by a three-axis positioner that moves the stage 300 in three axis directions which are the X, Y, Z directions by power generated by three motors. Each motor is driven under the control of the control unit 500. The position changing unit 400 may be configured to change the relative position between the nozzle 61 and the shaping surface 310 by moving the shaping unit 200 without moving the stage 300. The position changing unit 400 may be configured to change the relative position between the nozzle 61 and the shaping surface 310 by moving both the stage 300 and the shaping unit 200.

The control unit 500 is a control device that controls an overall operation of the three-dimensional shaping device 120. The control unit 500 is implemented by a computer including one or a plurality of processors, a main storage device, and an input and output interface that inputs a signal from the outside and outputs a signal to the outside. The computer includes a communication device that communicates with the data storage device 110 by wired communication or wireless communication. In the present embodiment, the control unit 500 exhibits various functions by the processor executing a program read from the main storage device or a command. The control unit 500 may be implemented by a combination of a plurality of circuits instead of the computer.

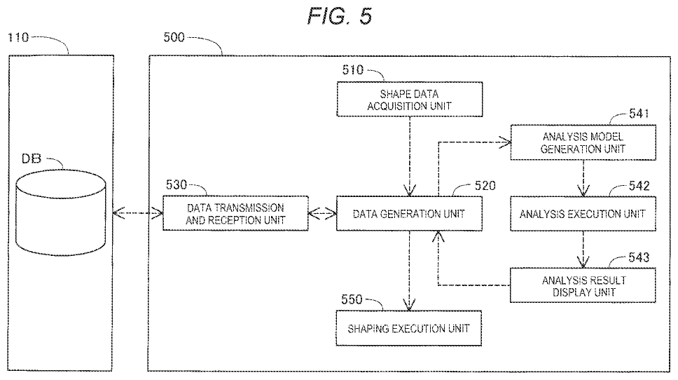

FIG. 5 is an explanatory diagram showing a configuration of the control unit 500 according to the present embodiment. In the present embodiment, the control unit 500 includes a shape data acquisition unit 510, a data generation unit 520, a data transmission and reception unit 530, an analysis model generation unit 541, an analysis execution unit 542, an analysis result display unit 543, and a shaping execution unit 550. The shape data acquisition unit 510, the data generation unit 520, the data transmission and reception unit 530, the analysis model generation unit 541, the analysis execution unit 542, the analysis result display unit 543, and the shaping execution unit 550 are implemented by software as a result of the processor of the control unit 500 executing a program.

The shape data acquisition unit 510 acquires shape data such as three-dimensional CAD data and three-dimensional CG data. The shape data acquisition unit 510 acquires, for example, shape data from a computer or a recording medium such as a USB memory coupled to the three-dimensional shaping device 120.

The data generation unit 520 controls the shaping unit 200 and the position changing unit 400 to generate shaping data representing a control command for shaping the three-dimensional shaped object. The data generation unit 520 generates the shaping data such that the three-dimensional shaped object is shaped in accordance with the shape represented by the shape data acquired by the shape data acquisition unit 510.

In the present embodiment, the data generation unit 520 generates slice data by dividing the shape represented by the shape data into a plurality of layers in accordance with the orientation and arrangement of the three-dimensional shaped object with respect to the stage 300 and the lamination pitch. The lamination pitch means a thickness of one layer.

The data generation unit 520 determines a tool path which is a movement path of the nozzle 61 for shaping each layer represented by the slice data, and generates tool path data representing the tool path. The data generation unit 520 determines the tool path in accordance with a discharge line width. The discharge line width means a width of a transverse section of the shaping material discharged from the nozzle 61 and deposited in a linear form on the stage 300 or on the already shaped layer.

Further, the data generation unit 520 determines manufacturing conditions other than the lamination pitch, the discharge line width, and the tool path. The manufacturing conditions include, in addition to the lamination pitch, the discharge line width, and the tool path, for example, a type of the material MR, a shaping chamber temperature which is a temperature of the shaping chamber RM when shaping the three-dimensional shaped object, a plasticization temperature which is the temperature of the heater 58 for plasticizing the material MR, a movement speed of the nozzle 61 moving relative to the stage 300 along the tool path, and a discharge amount of the shaping material discharged from the nozzle 61 moving relative to the stage 300 along the tool path.

After all the manufacturing conditions are determined, the data generation unit 520 generates manufacturing condition data representing the manufacturing conditions. When a support member that supports the three-dimensional shaped object is used in order to prevent deformation of the shape of the three-dimensional shaped object during shaping, the manufacturing conditions include a material of the support member and the like.

The data transmission and reception unit 530 has a function of transmitting various types of data such as the shaping data generated by the data generation unit 520 to the data storage device 110 and a function of receiving various types of data such as the shaping data from the data storage device 110.

The analysis model generation unit 541 generates an analysis model used for CAE analysis executed to predict the warpage amount and the residual stress of the three-dimensional shaped object. The analysis execution unit 542 reads the analysis model and executes the CAE analysis using a finite element method. In the present embodiment, the analysis execution unit 542 executes, as the CAE analysis, heat transfer and structure coupling analysis in which heat transfer analysis and structure analysis are combined. The analysis execution unit 542 outputs the analysis result data representing a result of the CAE analysis. The analysis result display unit 543 reads the analysis result data and causes the display unit 123 to display the result of the CAE analysis using, for example, a contour diagram, an animation, or a graph.

The shaping execution unit 550 reads the shaping data generated by the data generation unit 520 or the shaping data acquired by the data transmission and reception unit 530, and executes shaping processing for shaping the three-dimensional shaped object.

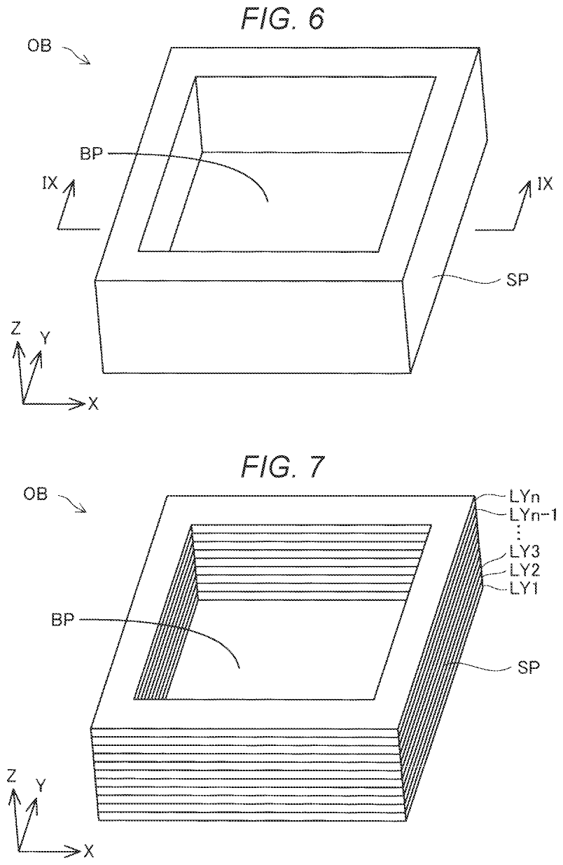

FIG. 6 is an explanatory diagram showing an example of the shape data. FIG. 6 shows, as an example, a shape of a three-dimensional shaped object OB. The three-dimensional shaped object OB has a box-shaped outer shape having a bottom surface portion BP and a side surface portion SP.

FIG. 7 is an explanatory diagram showing an example of the slice data. FIG. 7 shows, as an example, the three-dimensional shaped object OB divided into n layers. n is any natural number. The layers are referred to as a first layer LY1, a second layer LY2, and a third layer LY3 in order from a side closer to the shaping surface 310 of the stage 300. The layer farthest from the shaping surface 310 is referred to as an nth layer LYn.

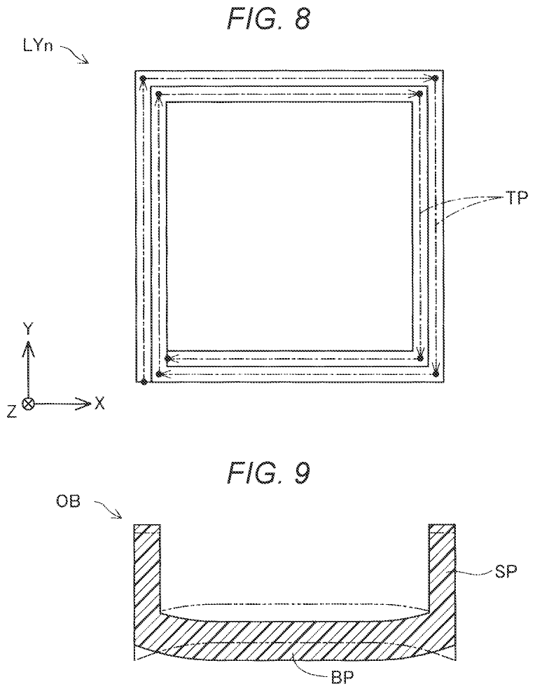

FIG. 8 is an explanatory diagram showing an example of the tool path data. In FIG. 8, as an example, a tool path TP for shaping the nth layer LYn of the three-dimensional shaped object OB is represented by a dashed line. In this example, the nth layer LYn is shaped as a single stroke by the tool path TP in which a plurality of linear tool path elements are combined.

FIG. 9 is an explanatory diagram showing an example of the analysis result data. FIG. 9 shows, as an example, a cross-sectional shape in a cross-section taken along a line IX-IX shown in FIG. 6 with respect to the shape of the three-dimensional shaped object OB after shaping predicted by the CAE analysis. In this example, the bottom surface portion BP of the three-dimensional shaped object OB is warped.

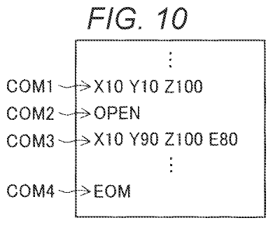

FIG. 10 is an explanatory diagram showing an example of the shaping data. FIG. 10 shows, as an example, a part of the shaping data for shaping the three-dimensional shaped object OB. In this example, control commands COM1 to COM4 for controlling the shaping unit 200 and the position changing unit 400 are shown. The control command COM1 represents coordinates of a movement destination of the nozzle 61 with respect to the stage 300. The control command COM2 represents a command to fully open the valve body 73 of the discharge amount adjustment unit 70. The control command COM3 represents the coordinates of the movement destination of the nozzle 61 with respect to the stage 300 and the discharge amount of the shaping material discharged from the nozzle 61 while the nozzle 61 moves to the movement destination. The control command COM4 represents a command to end the shaping processing.

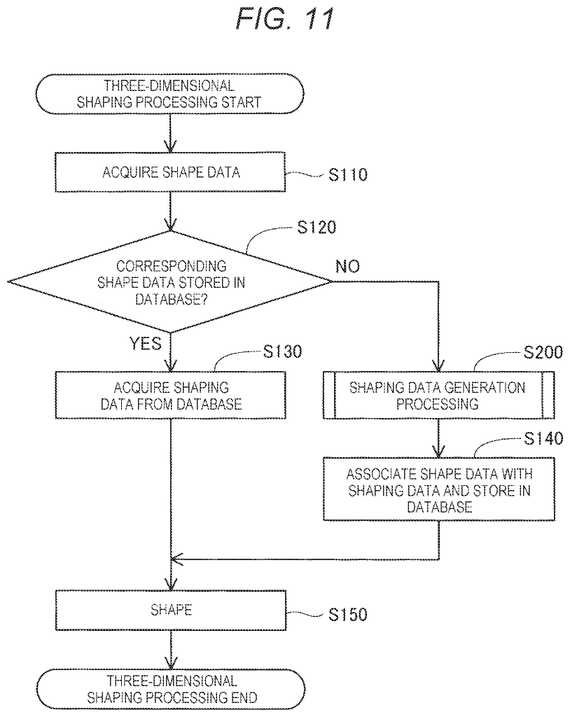

FIG. 11 is a flowchart showing contents of the three-dimensional shaping processing according to the present preferred embodiment. The flowchart shows a method of manufacturing the three-dimensional shaped object by the three-dimensional shaping system 100 according to the present embodiment. The processing is executed by the control unit 500 when a predetermined start command is supplied. The start command is supplied to the control unit 500, for example, when a start button of the operation panel 122 provided in the three-dimensional shaping device 120 is pressed.

First, in step S110, the shape data acquisition unit 510 of the control unit 500 acquires the shape data. The shape data acquisition unit 510 acquires the shape data from a computer or a recording medium such as a USB memory coupled to the three-dimensional shaping device 120. The shape data acquired by the shape data acquisition unit 510 is referred to as first shape data. The first shape data is transmitted to the data generation unit 520. The step of step S110 may be referred to as a first step.

Next, in step S120, the data generation unit 520 determines whether the shape data corresponding to the first shape data is stored in the database DB of the data storage device 110. The shape data corresponding to the first shape data is referred to as second shape data. The shape data corresponding to the first shape data includes not only the same shape data as the first shape data but also shape data representing the same shape as the shape represented by the first shape data and having a file format different from that of the first shape data. In the present embodiment, the data generation unit 520 handles the same shape data as the first shape data as the second shape data. The data generation unit 520 accesses the database DB via the data transmission and reception unit 530, inquires whether the second shape data is stored in the database DB, and determines that, when the second shape data is found from the database DB by the inquiry to the database DB, the second shape data is stored in the database DB. The step of step S120 may be referred to as a second step.

When it is determined in step S120 that the second shape data is stored in the database DB, in other words, when the second shape data is found from the database DB, in step S130, the data generation unit 520 acquires the shaping data associated with the second shape data from the database DB via the data transmission and reception unit 530. The shaping data associated with the second shape data and stored in the database DB is referred to as second shaping data. The acquired second shaping data is transmitted to the shaping execution unit 550. The step of step S130 may be referred to as a third step.

When it is determined in step S120 that the second shape data is not stored in the database DB, in other words, when the second shape data is not found from the database DB, in step S200, the data generation unit 520 generates the shaping data using the first shape data by executing the shaping data generation processing. The shaping data generated using the first shape data is referred to as first shaping data. Contents of the shaping data generation processing will be described later. The generated first shaping data is transmitted to the shaping execution unit 550. In step S140, the data generation unit 520 stores, in the database DB, the first shaping data generated by the shaping data generation processing and the first shape data in association with each other via the data transmission and reception unit 530. The step of step S200 may be referred to as the third step.

After step S130 or step S140, in step S150, the shaping execution unit 550 shapes the three-dimensional shaped object using the first shaping data or the second shaping data. The shaping execution unit 550 shapes the three-dimensional shaped object by controlling the shaping unit 200 and the position changing unit 400 in accordance with a control command represented by the first shaping data or the second shaping data. Thereafter, the shaping execution unit 550 ends the processing. The processing of step S140 may be executed after the processing of step S150. The processing of step S150 may be referred to as a fourth step.

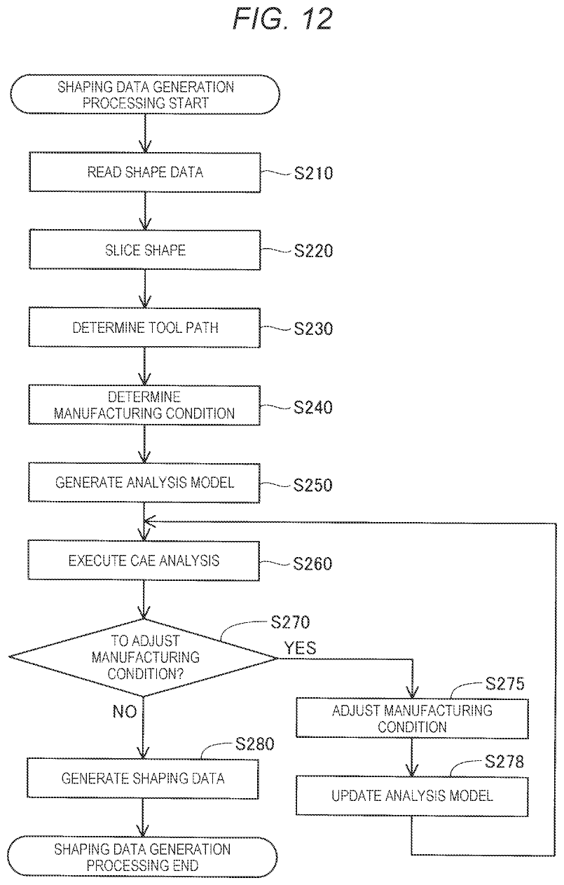

FIG. 12 is a flowchart showing the contents of the shaping data generation processing according to the present embodiment. When the shaping data generation processing is started, first, in step S210, the data generation unit 520 reads the first shape data acquired in step S110 in FIG. 11.

Next, in step S220, the data generation unit 520 divides the shape of the three-dimensional shaped object represented by the first shape data into a plurality of layers, and generates the slice data representing the shape of each layer. In the present embodiment, the data generation unit 520 divides the shape of the three-dimensional shaped object represented by the first shape data into the plurality of layers in accordance with the position, the orientation, and the lamination pitch of the three-dimensional shaped object with respect to the shaping surface 310 of the stage 300 designated by the user, and generates the slice data. The lamination pitch may be determined in accordance with the nozzle diameter stored in advance in the control unit 500. Since the shaping material shrinks when cooled and cured, the data generation unit 520 may generate the slice data by increasing a dimension of each layer in accordance with a shrinkage rate of the shaping material. Since the shrinkage rate of the shaping material is different for each material, in this case, for example, the type of the material is designated by the user prior to the generation of the slice data. The data generation unit 520 can determine the shrinkage rate by referring to a table indicating a relationship between the type of material stored in advance and the shrinkage rate.

In step S230, the data generation unit 520 determines the tool path and generates the tool path data representing the tool path. In the present embodiment, the data generation unit 520 determines the tool path for shaping each layer in accordance with the shape of each layer represented by the slice data and the discharge line width designated by the user, and generates the tool path data. The discharge line width may be determined in advance in accordance with the nozzle diameter stored in the control unit 500.

In step S240, the data generation unit 520 determines manufacturing conditions of the three-dimensional shaped object other than the already determined lamination pitch, tool path, discharge line width, and the like, and generates manufacturing condition data representing the manufacturing conditions. The data generation unit 520 determines the manufacturing conditions in accordance with, for example, the shaping chamber temperature and the plasticization temperature designated by the user. The manufacturing condition data represents, for example, the type of the material, the position and orientation of the three-dimensional shaped object with respect to the stage 300, the lamination pitch, the discharge line width, the tool path, the shaping chamber temperature, the plasticization temperature, the movement speed of the nozzle 61 moving along the tool path, and the discharge amount of the shaping material discharged from the nozzle 61 moving along the tool path.

In step S250, the analysis model generation unit 541 generates an analysis model for predicting the warpage amount and the residual stress of the three-dimensional shaped object. The analysis model generation unit 541 generates the analysis model using, for example, the first shape data, the slice data, the tool path data, and the manufacturing condition data. First, the analysis model generation unit 541 generates a mesh simulating the entire shape of the three-dimensional shaped object disposed on the stage 300. The mesh includes nodes and elements. As the element, for example, a hexahedral element having a hexahedral shape is used. When the support member is used, a mesh simulating the shape of the support member disposed on the stage 300 is included in addition to the entire shape of the three-dimensional shaped object.

Next, the analysis model generation unit 541 sets material characteristics, boundary conditions, and the like for the mesh to generate the analysis model. When the shaping material has a property as an elastic body, a material characteristic having linearity is set in the analysis model. When the shaping material has a property as a viscoelastic body or an elastic-plastic body, a material characteristic having nonlinearity is set in the analysis model.

The analysis model generation unit 541 further sets, for each element, a flag for switching whether to exclude the element from calculation in order to calculate a temporal change of a heat distribution in the three-dimensional shaped object being shaped and a temporal change of a stress distribution or a strain distribution in the three-dimensional shaped object being shaped. The element for which the flag is turned ON is included in the calculation. The element for which the flag is turned OFF is excluded from the calculation.

In step S260, the analysis execution unit 542 reads the analysis model and executes the CAE analysis. In the present embodiment, the analysis execution unit 542 executes the heat transfer and structure coupling analysis as the CAE analysis. The analysis execution unit 542 calculates the temporal change in the heat distribution, the temporal change in the stress distribution, and the temporal change in the strain distribution of the three-dimensional shaped object when the three-dimensional shaped object is shaped in an order determined by the tool path. The analysis execution unit 542 executes the calculation while sequentially switching the flag of each element to ON. For example, at a timing when the calculation of the heat distribution and the like of the three-dimensional shaped object in the state in which the shaping of the first layer is completed is completed, the flag of the element simulating the first layer is turned ON, and flags of the elements simulating the second and subsequent layers are turned OFF. At the timing when the calculation of the heat distribution and the like in the three-dimensional shaped object in the state in which the shaping of all the layers is completed is completed, the flags of all the elements are turned ON. After the calculation of the state in which the temperature of the three-dimensional shaped object decreases to a normal temperature is completed, the analysis execution unit 542 outputs the analysis result data representing the warpage amount and the residual stress of each portion of the three-dimensional shaped object.

In step S270, the data generation unit 520 determines whether to adjust the manufacturing conditions. In the present embodiment, the data generation unit 520 determines to adjust the manufacturing conditions when a maximum value of the warpage amount and a maximum value of the residual stress of the three-dimensional shaped object represented by the analysis result data exceed respective threshold values input in advance by the user. The data generation unit 520 may cause the display unit 123 to display the result of the CAE analysis via the analysis result display unit 543 to cause the user to determine whether to adjust the manufacturing conditions.

When it is determined in step S270 that the manufacturing condition is to be adjusted, the data generation unit 520 corrects, in step S275, the first shape data, the manufacturing condition data, the slice data, and the tool path data such that the maximum value of the warpage amount and the maximum value of the residual stress are equal to or less than respective threshold values. In the present embodiment, as indicated by a two-dot chain line in FIG. 9, the data generation unit 520 generates corrected shape data in which the three-dimensional shaped object represented by the first shape data is warped in a direction opposite to the direction of warpage represented by the analysis result data, and updates the slice data, the tool path data, and the manufacturing condition data using the corrected shape data.

In step S278, the analysis model generation unit 541 corrects the analysis model in accordance with the adjusted manufacturing conditions. Thereafter, the analysis execution unit 542 returns the processing to step S260, and executes the heat transfer and structure coupling analysis using the corrected analysis model. The processing from step S260 to step S278 is repeated until it is no longer determined that the manufacturing conditions are to be adjusted in step S270.

When it is determined in step S270 that the manufacturing condition is not to be adjusted, the data generation unit 520 generates the first shaping data using the tool path data and the manufacturing condition data in step S280. Thereafter, the data generation unit 520 ends the processing. As described above, the first shaping data generated by the processing is stored in the database DB of the data storage device 110 together with the first shape data in step S140 shown in FIG. 11. In step S150 shown in FIG. 11, the shaping execution unit 550 shapes the three-dimensional shaped object in accordance with the first shaping data.

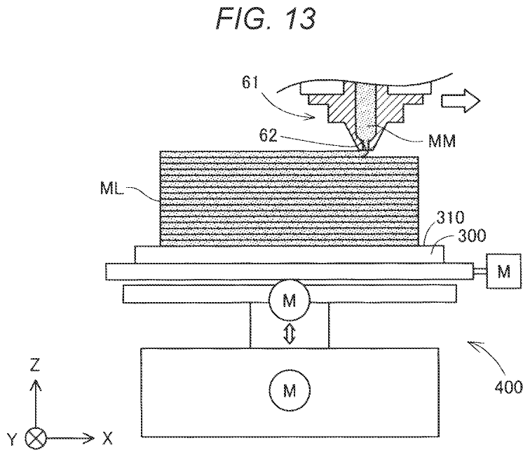

FIG. 13 is an explanatory diagram schematically showing a state in which the three-dimensional shaped object is shaped by the three-dimensional shaping device 120. In the three-dimensional shaping device 120, in the plasticization unit 30, a solid state material MR supplied to the groove portion 45 of the rotating flat screw 40 is plasticized to generate a shaping material MM. The shaping execution unit 550 causes the shaping material MM to be discharged from the nozzle 61 while changing the position of the nozzle 61 with respect to the shaping surface 310 while keeping a distance between the shaping surface 310 of the stage 300 and the nozzle 61 constant. The shaping material MM discharged from the nozzle 61 is linearly deposited along a tool path along which the nozzle 61 moves.

The shaping execution unit 550 repeats discharging of the shaping material MM from the nozzle 61 to form a layer ML. After one layer ML is formed, the shaping execution unit 550 moves the position of the nozzle 61 with respect to the shaping surface 310 in a +Z direction. Then, layers ML are further stacked on the layers ML formed so far, to shape three-dimensional shaped object. While the three-dimensional shaped object is shaped, the shaping chamber temperature is maintained at a constant temperature.

For example, when the nozzle 61 is moved in the +Z direction with respect to the shaping surface 310 after the formation of one layer ML is completed, or when there is a discontinuous tool path when one layer is formed, the shaping execution unit 550 may temporarily interrupt the discharge of the shaping material MM from the nozzle 61. In this case, the shaping execution unit 550 stops the discharge of the shaping material MM from the nozzle 61 by closing the flow path 65 by the valve body 73 of the discharge amount adjustment unit 70. After the shaping execution unit 550 changes the position of the nozzle 61, the valve body 73 of the discharge amount adjustment unit 70 opens the flow path 65, so that deposition of the shaping material MM from a changed position of the nozzle 61 is resumed.

According to the three-dimensional shaping system 100 in the present embodiment described above, the database DB of the data storage device 110 stores a plurality of pieces of shape data and a plurality of pieces of shaping data generated using each piece of shape data in association with each other. Therefore, when the second shape data, which is the shape data corresponding to the first shape data, is found from the database DB, the control unit 500 of the three-dimensional shaping device 120 can acquire the second shaping data associated with the second shape data from the database DB without generating the first shaping data from the first shape data, and shape the three-dimensional shaped object by reusing the second shaping data. Therefore, it is possible to prevent a large amount of time from being taken to generate the first shaping data.

In the present embodiment, when the first shaping data is generated using the first shape data, the control unit 500 transmits the first shape data and the first shaping data to the data storage device 110, and the data storage device 110 stores the first shape data and the first shaping data in the database DB in association with each other. Therefore, when shaping the three-dimensional shaped object having the same shape a plurality of times, the first shaping data generated in the first shaping can be reused as the second shaping data in the second and subsequent shaping. In particular, in the present embodiment, the control unit 500 generates the first shaping data by adjusting the manufacturing conditions such that the maximum value of the warpage amount and the maximum value of the residual stress of the three-dimensional shaped object are equal to or less than the respective threshold values by executing the CAE analysis prior to the first shaping. Therefore, it is possible to shape the three-dimensional shaped object with high dimensional accuracy. At the time of the second and subsequent shaping, the three-dimensional shaped object is shaped by reusing the first shaping data used at the time of the first shaping. Therefore, the three-dimensional shaped object can be shaped with high dimensional accuracy without executing the CAE analysis and adjusting the manufacturing conditions.

### B. Second Embodiment

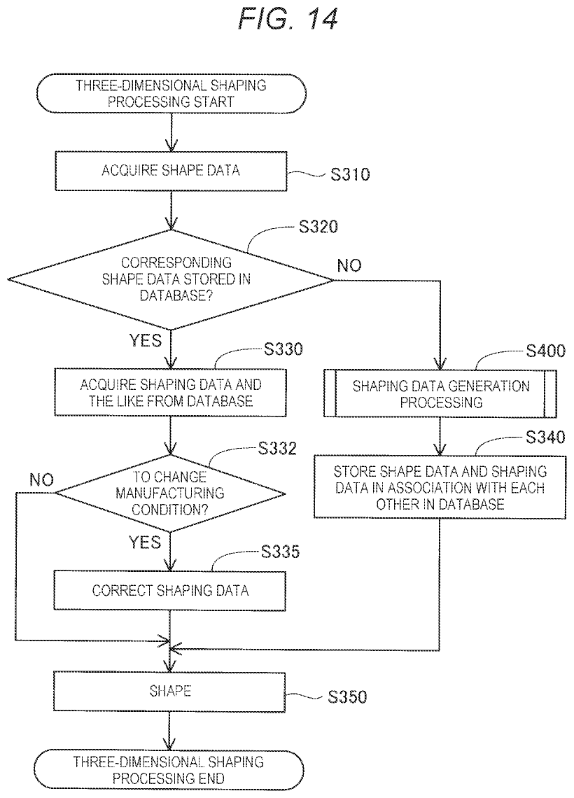

FIG. 14 is a flowchart showing contents of three-dimensional shaping processing according to a second embodiment. The flowchart shows a method of manufacturing the three-dimensional shaped object by a three-dimensional shaping system 100b according to the present embodiment. The second embodiment is different from the first embodiment in that a control unit 500b of the three-dimensional shaping device 120 determines whether to change the manufacturing condition when second shaping data is acquired from the database DB of the data storage device 110, and corrects the second shaping data acquired from the database DB when the control unit 500b determines to change the manufacturing condition. Other configurations are the same as those in the first embodiment unless otherwise specified.

When the three-dimensional shaping processing shown in FIG. 14 is started, first, in step S310, the shape data acquisition unit 510 acquires first shape data. Next, in step S320, the data generation unit 520 determines whether the second shape data, which is shape data corresponding to the first shape data, is stored in the database DB. In the present embodiment, the database DB of the data storage device 110 stores corrected shape data, slice data, tool path data, manufacturing condition data, analysis result data, shaping data, and shaping chamber temperature data indicating a shaping chamber temperature acquired by the thermometer 126 when the three-dimensional shaped object is shaped using the shaping data, which are generated by the shaping data generation processing, in association with the shape data. The corrected shape data, the slice data, the tool path data, the manufacturing condition data, the analysis result data, and the shaping chamber temperature data associated with the second shape data may be referred to as related data. The related data is data related to the second shaping data. Among the data associated with the second shape data, the data used to generate the second shaping data, which is the shaping data associated with the second shape data, may be referred to as generation data. The step of step S310 may be referred to as a first step. The step of step S320 may be referred to as a second step.

When it is determined in step S320 that the second shape data is not stored in the database DB, in step S400, the data generation unit 520 generates the first shaping data using the first shape data by executing the shaping data generation processing shown in FIG. 12. In step S340, the data generation unit 520 transmits the corrected shape data, the slice data, the tool path data, the manufacturing condition data, the analysis result data, and the first shaping data generated using the first shape data to the database DB via the data transmission and reception unit 530 together with the first shape data. The step of step S400 may be referred to as a third step.

When it is determined in step S320 that the second shape data is stored in the database DB, in step S330, the data generation unit 520 acquires the corrected shape data, the slice data, the tool path data, the manufacturing condition data, the analysis result data, the second shaping data, and the shaping chamber temperature data associated with the second shape data from the database DB via the data transmission and reception unit 530.

In step S332, the data generation unit 520 determines whether the manufacturing condition determined when the second shaping data is generated using the second shape data is different from the manufacturing condition of the three-dimensional shaped object shaped by the processing. When the temperature of the shaping chamber RM, which is raised, in preparation for shaping of the three-dimensional shaped object is acquired by the thermometer 126, and an absolute value of a difference between the acquired temperature and the temperature represented by the shaping chamber temperature data is equal to or greater than a predetermined value, the data generation unit 520 determines that the manufacturing condition determined when the second shaping data is generated using the second shape data is different from the manufacturing condition of the three-dimensional shaped object. In another embodiment, the data generation unit 520 may cause the display unit 123 to display a selection screen for selecting whether to change the manufacturing condition. When an instruction to change the manufacturing condition is input via the operation panel 122, the data generation unit 520 may determine that the manufacturing condition determined when the second shaping data is generated using the second shape data is different from the manufacturing condition of the three-dimensional shaped object.

When it is determined in step S332 that the manufacturing condition determined when the second shaping data is generated using the second shape data and the manufacturing condition of the three-dimensional shaped object are different from each other, in step S335, the data generation unit 520 corrects the second shaping data and the like acquired from the database DB in accordance with a change content of the manufacturing condition. In the present embodiment, the data generation unit 520 first corrects the corrected shape data acquired from the database DB. As described above, the corrected shape data represents the shape of the three-dimensional shaped object that is warped in the direction opposite to the warp calculated by the CAE analysis. When the temperature acquired by the thermometer 126 is higher than the temperature represented by the shaping chamber temperature data, the data generation unit 520 corrects the corrected shape data by multiplying the warpage amount in the opposite direction by a correction coefficient such that the warpage amount in the opposite direction of the three-dimensional shaped object represented by the corrected shape data becomes large. On the other hand, when the temperature acquired by the thermometer 126 is lower than the temperature represented by the shaping chamber temperature data, the data generation unit 520 corrects the corrected shape data by multiplying the warpage amount in the opposite direction by a correction coefficient such that the warpage amount in the opposite direction of the three-dimensional shaped object represented by the corrected shape data becomes smaller. The data generation unit 520 can correct the corrected shape data using a map or a function representing a relationship between the shaping chamber temperature and the correction coefficient. The map and the function can be created by a test or a CAE analysis performed in advance. Thereafter, the data generation unit 520 corrects the slice data, the tool path data, the manufacturing condition data, and the second shaping data acquired from the database DB in accordance with a correction content of the corrected shape data. Correction of the slice data, the tool path data, the manufacturing condition data, and the second shaping data acquired from the database DB includes generating the slice data, the tool path data, the manufacturing condition data, and the shaping data by using the corrected shape data after correction.

When it is determined in step S332 that the manufacturing condition determined when the second shaping data is generated using the second shape data is not different from the manufacturing condition of the three-dimensional shaped object, the data generation unit 520 skips the processing of step S335. The step from step S330 to step S335 may be referred to as the third step.

After step S335 or step S340, in step S350, the shaping execution unit 550 shapes the three-dimensional shaped object using the first shaping data, the second shaping data that is not corrected, or the corrected second shaping data. When the three-dimensional shaped object is shaped using the first shaping data, the data generation unit 520 acquires the temperature measured by the thermometer 126 when shaping the three-dimensional shaped object, generates the shaping chamber temperature data, and transmits the shaping chamber temperature data to the database DB via the data transmission and reception unit 530. The shaping chamber temperature data is stored in the database DB in association with the first shape data. Thereafter, the shaping execution unit 550 ends the processing. The step of step S350 may be referred to as a fourth step.

According to the three-dimensional shaping system 100b in the present embodiment described above, when the second shape data is stored in the database DB and it is determined that the manufacturing condition determined when the second shaping data is generated using the second shape data is different from the manufacturing condition of the three-dimensional shaped object, the data generation unit 520 corrects the second shaping data and the like by correcting the corrected shape data acquired from the database DB. Therefore, even when the manufacturing condition determined when the second shaping data is generated using the second shape data is different from the manufacturing condition of the three-dimensional shaped object, the corrected shape data acquired from the database DB can be reused. In particular, in the present embodiment, the data generation unit 520 corrects the corrected shape data acquired from the database DB without executing the CAE analysis by the analysis execution unit 542, and then corrects the slice data, the tool path data, the manufacturing condition data, and the second shaping data in accordance with the correction content of the corrected shape data. Therefore, the second shaping data and the like for shaping the three-dimensional shaped object under the changed manufacturing conditions can be easily corrected.

### C. Third Embodiment

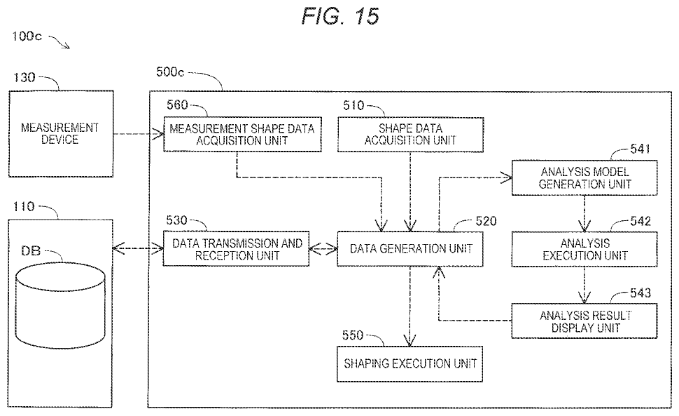

FIG. 15 is an explanatory diagram showing a schematic configuration of a three-dimensional shaping system 100c according to a third embodiment. In FIG. 15, only a control unit 500c is shown for the three-dimensional shaping device 120, and the shaping unit 200 and the like are not shown. The third embodiment is different from the first embodiment in that the three-dimensional shaping system 100c includes a measurement device 130 and that the data generation unit 520 corrects second shaping data acquired from the database DB in accordance with a measurement result of a three-dimensional shaped object by the measurement device 130. Other configurations are the same as those in the first embodiment unless otherwise specified.

The measurement device 130 measures a dimension of the three-dimensional shaped object shaped by the three-dimensional shaping device 120. In the present embodiment, the measurement device 130 is implemented by a non-contact type three-dimensional digitizer that measures the shape of the three-dimensional shaped object using laser light or the like. The measurement device 130 may be implemented by a contact type three-dimensional digitizer that measures the shape of the three-dimensional shaped object using a probe or the like. The measurement device 130 measures the dimension of the three-dimensional shaped object, and generates three-dimensional CAD data, three-dimensional CG data, or the like representing the measured shape of the three-dimensional shaped object. In the following description, the three-dimensional CAD data and the three-dimensional CG data generated by the measurement device 130 are referred to as measurement shape data.

In the present embodiment, the control unit 500c includes a measurement shape data acquisition unit 560 that acquires the measurement shape data from the measurement device 130, in addition to the shape data acquisition unit 510, the data generation unit 520, and the like shown in FIG. 5.

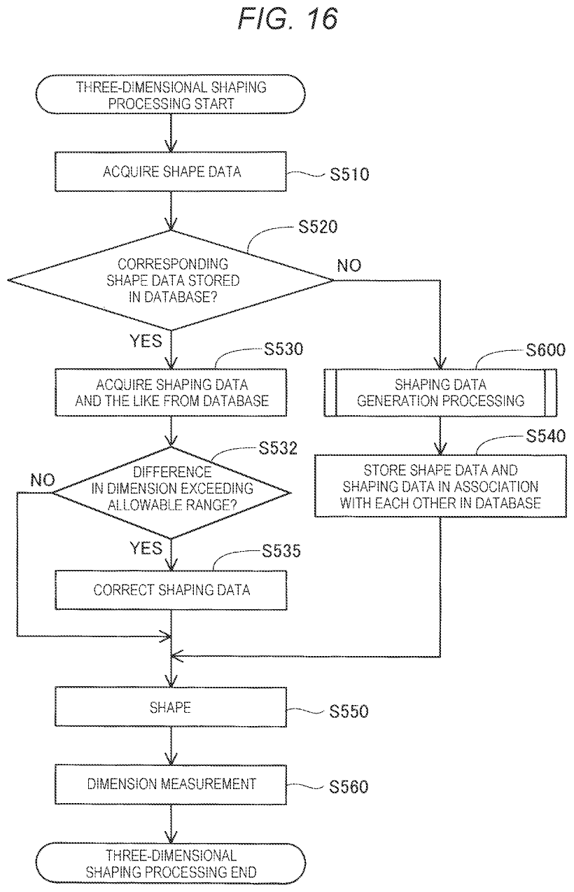

FIG. 16 is a flowchart showing contents of the three-dimensional shaping processing according to the present embodiment. The flowchart shows a method of manufacturing the three-dimensional shaped object by the three-dimensional shaping system 100c according to the present embodiment. When the three-dimensional shaping processing shown in FIG. 16 is started, first, in step S510, the shape data acquisition unit 510 acquires first shape data. Next, in step S520, the data generation unit 520 determines whether the second shape data, which is shape data corresponding to the first shape data, is stored in the database DB. In the present embodiment, in the database DB of the data storage device 110, the corrected shape data, the slice data, the tool path data, the manufacturing condition data, the analysis result data, the shaping data, and the measurement shape data generated by the shaping data generation processing are stored in association with the shape data. The corrected shape data, the slice data, the tool path data, the manufacturing condition data, the analysis result data, and the measurement shape data associated with the second shape data may be referred to as related data. Among the data associated with the second shape data, the data used to generate the second shaping data, which is the shaping data associated with the second shape data, may be referred to as generation data. The step of step S510 may be referred to as a first step. The step of step S520 may be referred to as a second step.

When it is determined in step S520 that the second shape data is not stored in the database DB, in step S600, the data generation unit 520 generates the first shaping data using the first shape data by executing the shaping data generation processing shown in FIG. 12. In step S540, the data generation unit 520 transmits the corrected shape data, the slice data, the tool path data, the manufacturing condition data, and the first shaping data generated using the first shape data to the database DB together with the first shape data via the data transmission and reception unit 530. The step of step S600 may be referred to as a third step.

When it is determined in step S520 that the second shape data is stored in the database DB, in step S530, the data generation unit 520 acquires the corrected shape data, the slice data, the tool path data, the manufacturing condition data, the analysis result data, the second shaping data, and the measurement shape data associated with the second shape data from the database DB via the data transmission and reception unit 530.

In step S532, the data generation unit 520 determines whether a degree of difference between the dimension of the three-dimensional shaped object represented by the first shape data and the dimension of the three-dimensional shaped object represented by the measurement shape data acquired from the database DB exceeds an allowable range. In the present embodiment, the data generation unit 520 calculates the warpage amount represented by the measurement shape data using the dimension of the three-dimensional shaped object represented by the first shape data and the dimension of the three-dimensional shaped object represented by the measurement shape data, and determines that the degree of difference between the dimension of the three-dimensional shaped object represented by the first shape data and the dimension of the three-dimensional shaped object represented by the measurement shape data exceeds the allowable range when an absolute value of the warpage amount exceeds a predetermined threshold value.

When it is determined in step S532 that the degree of difference between the dimension of the three-dimensional shaped object represented by the first shape data and the dimension of the three-dimensional shaped object represented by the measurement shape data exceeds the allowable range, the data generation unit 520 corrects the second shaping data and the like acquired from the database DB in step S535. In the present embodiment, the data generation unit 520 first corrects the corrected shape data acquired from the database DB. As described above, the corrected shape data represents the shape of the three-dimensional shaped object that is warped in the direction opposite to the warp calculated by the CAE analysis. When the direction of the warpage represented by the corrected shape data is opposite to the direction of the warpage represented by the measurement shape data, the data generation unit 520 corrects the corrected shape data by multiplying the warpage amount in the opposite direction by a correction coefficient such that the warpage amount in the opposite direction of the three-dimensional shaped object represented by the corrected shape data becomes large. On the other hand, when the direction of the warpage represented by the corrected shape data is the same as the direction of the warpage represented by the measurement shape data, the data generation unit 520 corrects the corrected shape data by multiplying the warpage amount in the opposite direction by a correction coefficient such that the warpage amount in the opposite direction of the three-dimensional shaped object represented by the corrected shape data becomes small. Thereafter, the data generation unit 520 corrects the slice data, the tool path data, the manufacturing condition data, and the second shaping data acquired from the database DB in accordance with a correction content of the corrected shape data. The data generation unit 520 transmits the corrected shape data, the slice data, the tool path data, the manufacturing condition data, and the second shaping data after correction via the data transmission and reception unit 530, and updates the data stored in the database DB.

When it is determined in step S532 that the degree of difference between the dimension of the three-dimensional shaped object represented by the first shape data and the dimension of the three-dimensional shaped object represented by the measurement shape data does not exceed the allowable range, the data generation unit 520 skips the processing of step S535. The step from step S530 to step S535 may be referred to as the third step.

After step S535 or step S540, in step S550, the shaping execution unit 550 shapes the three-dimensional shaped object using the first shaping data, the second shaping data that is not corrected, or the corrected second shaping data. The step of step S550 may be referred to as a fourth step.

In step S560, the data generation unit 520 acquires the measurement shape data measured by the measurement device 130 via the measurement shape data acquisition unit 560. The data generation unit 520 transmits the measurement shape data to the database DB via the data transmission and reception unit 530. When the three-dimensional shaped object is shaped using the first shaping data, the data generation unit 520 stores the measurement shape data in the database DB in association with the first shape data. When the three-dimensional shaped object is shaped using the second shaping data that is not corrected or the corrected second shaping data, the data generation unit 520 updates the measurement shape data stored in the database DB. Thereafter, the shaping execution unit 550 ends the processing. The step of step S560 may be referred to as a fifth step.

According to the three-dimensional shaping system 100c in the present embodiment described above, when it is determined that the degree of difference between the dimension of the three-dimensional shaped object represented by the first shape data and the dimension of the three-dimensional shaped object represented by the measurement shape data acquired from the database DB exceeds the allowable range, the data generation unit 520 corrects the corrected shape data acquired from the database DB, corrects the slice data, the tool path data, the manufacturing condition data, and the second shaping data in accordance with the correction content of the corrected shape data, and updates the data stored in the database DB. Therefore, when the three-dimensional shaped object is shaped a plurality of times using the same shape data, even if a difference occurs between the warpage amount of the three-dimensional shaped object predicted by the CAE analysis and the warpage amount of the shaped three-dimensional shaped object, the degree of difference between the dimension of the three-dimensional shaped object represented by the first shape data and the dimension of the three-dimensional shaped object represented by the measurement shape data can be reduced each time the number of times of shaping increases.

### D. Fourth Embodiment

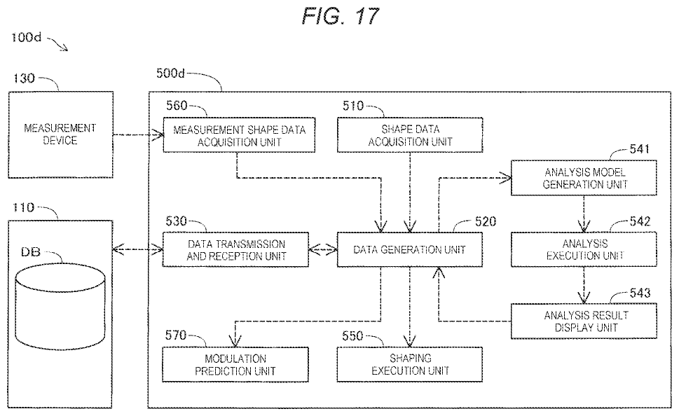

FIG. 17 is an explanatory diagram showing a schematic configuration of a three-dimensional shaping system 100d according to a fourth embodiment. In FIG. 17, only a control unit 500d is shown for the three-dimensional shaping device 120, and the shaping unit 200 and the like are not shown. The fourth embodiment is different from the first embodiment in that the three-dimensional shaping system 100d includes the measurement device 130, and a modulation prediction unit 570 that predicts modulation of the three-dimensional shaping device 120 is provided in the control unit 500d of the three-dimensional shaping device 120. Other configurations are the same as those in the first embodiment unless otherwise specified. The configuration of the measurement device 130 is the same as that of the third embodiment.

In the present embodiment, the control unit 500d includes, in addition to the shape data acquisition unit 510, the data generation unit 520, and the like shown in FIG. 5, the measurement shape data acquisition unit 560 that acquires measurement shape data from the measurement device 130, and the modulation prediction unit 570 described above.

Every time the three-dimensional shaping processing is executed, the modulation prediction unit 570 acquires the degree of difference between the dimension of the three-dimensional shaped object represented by the first shape data and the dimension of the three-dimensional shaped object represented by the measurement shape data, and stores the degree in time series. The modulation prediction unit 570 learns a state of a time series change in the degree of difference by machine learning. An algorithm of the machine learning may be supervised learning, unsupervised learning, or reinforcement learning. The modulation prediction unit 570 predicts, using a learning result, a timing at which the modulation occurs in the three-dimensional shaping device 120. The modulation prediction unit 570 predicts, for example, the remaining number of times of shaping until the timing at which the modulation occurs in the three-dimensional shaping device 120. The modulation prediction unit 570 displays a prediction result on the display unit 123. The modulation prediction unit 570 may predict, by a method other than the machine learning, the timing at which the modulation occurs in the three-dimensional shaping device 120. For example, the modulation prediction unit 570 may predict that the modulation will occur in the three-dimensional shaping device 120 at the time of the next shaping when the degree of difference at the time of the previous shaping and the current difference exceed a predetermined value.

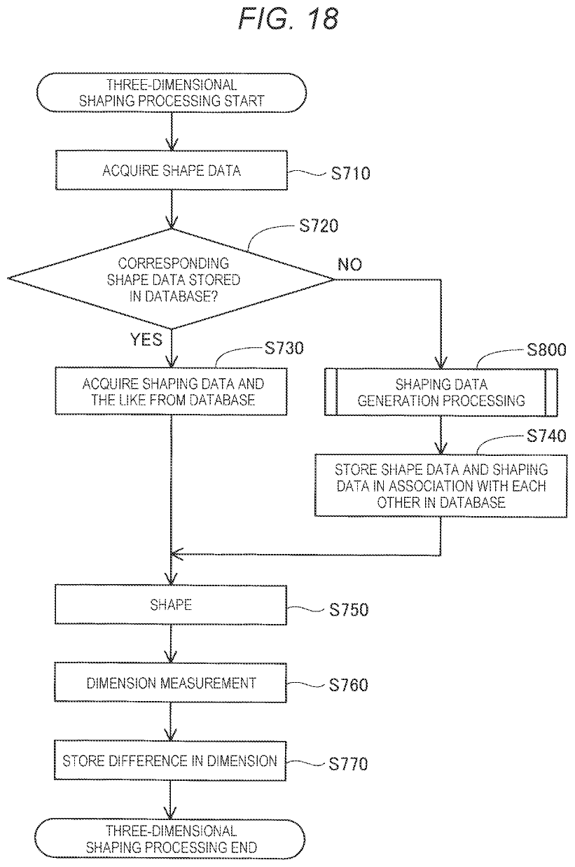

FIG. 18 is a flowchart showing contents of the three-dimensional shaping processing according to the present embodiment. The flowchart shows a method of manufacturing the three-dimensional shaped object by the three-dimensional shaping system 100d according to the present embodiment. When the three-dimensional shaping processing shown in FIG. 18 is started, first, in step S710, the shape data acquisition unit 510 acquires first shape data. Next, in step S720, the data generation unit 520 determines whether the second shape data, which is shape data corresponding to the first shape data, is stored in the database DB. The step of step S710 may be referred to as a first step. The step of step S720 may be referred to as a second step.

When it is determined in step S720 that the second shape data is stored in the database DB, in step S730, the data generation unit 520 acquires the second shaping data from the database DB via the data transmission and reception unit 530. The step of step S730 may be referred to as a third step.

When it is determined in step S720 that the second shape data is not stored in the database DB, in step S800, the data generation unit 520 generates the first shaping data using the first shape data by executing the shaping data generation processing shown in FIG. 12. In step S740, the data generation unit 520 transmits the first shaping data together with the first shape data to the database DB via the data transmission and reception unit 530. The step of step S800 may be referred to as a third step.

After step S730 or step S740, in step S750, the shaping execution unit 550 shapes the three-dimensional shaped object using the first shaping data or the second shaping data. The step of step S750 may be referred to as a fourth step.

In step S760, the data generation unit 520 acquires the measurement shape data measured by the measurement device 130 via the measurement shape data acquisition unit 560, and calculates the degree of difference between the dimension of the three-dimensional shaped object represented by the first shape data and the dimension of the three-dimensional shaped object represented by the measurement shape data. The step of step S760 may be referred to as a fifth step.

In step S770, the modulation prediction unit 570 acquires the degree of difference from the data generation unit 520 and stores the degree of difference in time series. Thereafter, the shaping execution unit 550 ends the processing.

According to the three-dimensional shaping system 100d in the present embodiment described above, since the timing at which the modulation occurs in the three-dimensional shaping device 120 due to aging of a component of the three-dimensional shaping device 120 or the like can be predicted by the modulation prediction unit 570, it is possible to prevent a three-dimensional shaped object having low dimensional accuracy from being shaped by the modulation of the three-dimensional shaping device 120.

### E. Fifth Embodiment

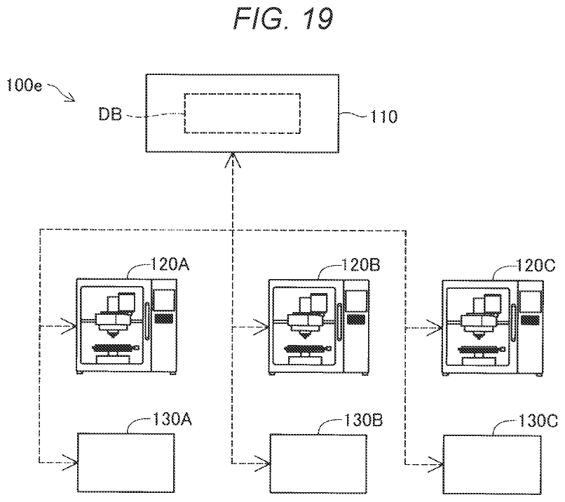

FIG. 19 is an explanatory diagram showing a schematic configuration of a three-dimensional shaping system 100e according to a fifth embodiment. The fifth embodiment is different from the third embodiment in that the three-dimensional shaping system 100e includes one data storage device 110, three three-dimensional shaping devices 120A to 120C, and three measurement devices 130A to 130C. Other configurations are the same as those of the third embodiment shown in FIG. 15 unless otherwise specified.

The three-dimensional shaping devices 120A to 120C and the measurement devices 130A to 130C are disposed in a distributed manner in, for example, three factories. The three-dimensional shaping device 120A and the measurement device 130A are disposed in a first factory. The three-dimensional shaping device 120B and the measurement device 130B are disposed in a second factory. The three-dimensional shaping device 120C and the measurement device 130C are disposed in a third factory. All of the three-dimensional shaping devices 120A to 120C and the measurement devices 130A to 130C may be disposed in the same factory. The number of the three-dimensional shaping devices 120 is not limited to three, and may be two or four or more. The number of measurement devices 130 is not limited to three, and may be two or four or more. The number of the three-dimensional shaping devices 120 and the number of the measurement devices 130 may be different. At least one measurement device 130 may be disposed at a place where the three-dimensional shaping device 120 is disposed.

In the present embodiment, the configuration of each of the three-dimensional shaping devices 120A to 120C is the same as that of the three-dimensional shaping device 120 according to the third embodiment. The configuration of each of the measurement devices 130A to 130C is the same as that of the measurement device 130 according to the third embodiment. The control unit 500c of each of the three-dimensional shaping devices 120A to 120C may not include the analysis model generation unit 541, the analysis execution unit 542, and the analysis result display unit 543. In this case, for example, the analysis model generation unit 541, the analysis execution unit 542, and the analysis result display unit 543 may be provided in the data storage device 110, and the CAE analysis may be executed on the data storage device 110.

In the present embodiment, the control unit 500c of each of the three-dimensional shaping devices 120A to 120C executes the three-dimensional shaping processing shown in FIG. 16. For example, the shaping data generated by the three-dimensional shaping device 120A can be used by other three-dimensional shaping devices 120B and 120C via the database DB.

According to a three-dimensional shaping system 100e in the present embodiment described above, since the shaping data stored in the database DB can be reused by a plurality of three-dimensional shaping devices, a plurality of three-dimensional shaped objects having the same shape can be shaped at once by the plurality of three-dimensional shaping devices 120A to 120C.

### F. Other Embodiments

(F1) In the three-dimensional shaping system 100 according to the first embodiment and the three-dimensional shaping system 100b according to the second embodiment described above, the data generation unit 520 transmits the first shaping data generated using the first shape data to the data storage device 110 in the three-dimensional shaping processing. In contrast, the data generation unit 520 may not transmit the first shaping data to the data storage device 110. Even in this case, when the shape data acquisition unit 510 acquires the same shape data as the shape data stored in the database DB of the data storage device 110, the shaping data stored in the database DB can be reused.

(F2) In the three-dimensional shaping system 100e according to the fifth embodiment described above, the three-dimensional shaping devices 120A to 120C have the same configuration as the three-dimensional shaping device 120 according to the third embodiment, and perform the same three-dimensional shaping processing as the three-dimensional shaping processing according to the third embodiment. In contrast, the three-dimensional shaping devices 120A to 120C may have the same configuration as the three-dimensional shaping processing in the first embodiment and execute the same three-dimensional shaping processing as the three-dimensional shaping processing in the first embodiment, may have the same configuration as the three-dimensional shaping processing in the second embodiment and execute the same three-dimensional shaping processing as the three-dimensional shaping processing in the second embodiment. The three-dimensional shaping devices 120A to 120C may have the same configuration as the three-dimensional shaping processing in the fourth embodiment and execute the same three-dimensional shaping processing as the three-dimensional shaping processing in the fourth embodiment.

(F3) In the three-dimensional shaping device 120 of the three-dimensional shaping systems 100 to 100e according to the above-described embodiments, the three-dimensional shaped object is shaped in the shaping chamber RM heated by the shaping chamber heater 125. In contrast, the three-dimensional shaped object may be shaped in a state in which the shaping chamber RM is at normal temperature. That is, the opening and closing door 124 and the shaping chamber heater 125 may not be provided in the three-dimensional shaping device 120.

(F4) In the three-dimensional shaping systems 100 to 100e according to the above-described embodiments, the three-dimensional shaping device 120 melts the material MR by the rotation of the flat screw 40 and the heating by the heater 58 to generate the shaping material MM, and discharges the shaping material from the nozzle 61 to laminate the shaping material on the stage 300 to shape the three-dimensional shaped object. In contrast, the three-dimensional shaping device 120 may be a thermal melting lamination method in which a filament of a thermoplastic resin or the like is melted and extruded, a stereolithography method in which a liquid photocurable resin is irradiated and cured with light, an ink jet method in which a melted thermoplastic resin or the like is injected to be laminated, a binder jet method in which a liquid binder is injected to a powdery thermoplastic resin, gypsum, or the like, or a powder sintering lamination shaping method in which a powdery thermoplastic resin, an alloy, or the like is melted by a laser or a discharge to be sintered.

(F5) In the three-dimensional shaping systems 100 to 100e according to the above-described embodiments, the ABS resin in a pellet form is used as the material MR, but as the material MR used in the shaping unit 200, for example, a material for shaping a three-dimensional shaped object by using various materials such as ae material having thermoplasticity, a metal material, and a ceramic material as main materials may be adopted. Here, the “main material” refers to a material serving as a center component for forming a shape of the three-dimensional shaped object, and refers to a material having a content of 50 mass % or more in the three-dimensional shaped object. The shaping materials described above include those in which the main materials are melted alone, and those in which a part of the components contained together with the main materials are melted to form a paste.

When the thermoplastic material is used as the main material, the plasticization unit 30 generates a shaping material by plasticizing the thermoplastic material. The term “plasticization” refers to that a thermoplastic material is heated and melted. The term “melt” means that the material having thermoplasticity is softened by being heated to a temperature equal to or higher than the glass transition point and exhibits fluidity.

As the material having thermoplasticity, for example, any one of the following thermoplastic resin materials or a combination of two or more thereof can be used.

### Example of Thermoplastic Resin Material

General engineering plastics such as polypropylene resin (PP), polyethylene resin (PE), polyacetal resin (POM), polyvinyl chloride resin (PVC), polyamide resin (PA), acrylonitrile-butadiene-styrene resin (ABS), polylactic acid resin (PLA), polyphenylene sulfide resin (PPS), polycarbonate (PC), modified polyphenylene ether, polybutylene terephthalate, and polyethylene terephthalate, and engineering plastics such as polysulfone, polyethersulfone, polyphenylene sulfide, polyarylate, polyimide, polyamideimide, polyetherimide, and polyether ether ketone (PEEK)

An additive such as a wax, a flame retardant, an antioxidant, and a heat stabilizer may be mixed into the thermoplastic material, in addition to a pigment, a metal, and a ceramic. In the plasticization unit 30, the material having thermoplasticity is converted into a melted state by being plasticized by the rotation of the flat screw 40 and the heating of the heater 58. After the shaping material formed in such a manner is discharged from the nozzle 61, the shaping material is cured due to a reduction in temperature.

It is desirable that the thermoplastic material is discharged from the nozzle 61 in a state in which the material is heated to a temperature equal to or higher than the glass transition point thereof and is melted completely. The “state of being melted completely” refers to a state in which no unmelted thermoplastic material is present, and refers to a state in which no pellet-like solid object remains when, for example, a pellet-like thermoplastic resin is used in a material.

In the shaping unit 200, for example, the following metal material may be used as the main material instead of the above-described material having thermoplasticity. In this case, it is desirable that a component to be melted at the time of forming the shaping material is mixed into a powder material obtained by converting the following metal material into a powder, and then the mixture is charged into the plasticization unit 30.

### Example of Metal Material

Single metals such as magnesium (Mg), iron (Fe), cobalt (Co), chromium (Cr), aluminum (Al), titanium (Ti), copper (Cu), and nickel (Ni), or an alloy containing one or more of these metals

### Example of Alloy

Maraging steel, stainless steel, cobalt chrome molybdenum, titanium alloy, nickel alloy, aluminum alloy, cobalt alloy, and cobalt chromium alloy

In the shaping unit 200, a ceramic material may be used as a main material instead of the above-described metal material. Examples of the ceramic material may include an oxide ceramic such as silicon dioxide, titanium dioxide, aluminum oxide, and zirconium oxide, and a non-oxide ceramic such as aluminum nitride. When the above metal material or ceramic material is used as the main material, the shaping material disposed on the stage 300 may be cured by, for example, sintering with laser irradiation or warm air.

A powder material of the metal material or the ceramic material to be charged into the material supply unit 20 may be a mixed material obtained by mixing a plurality of types of powders of a single metal or an alloy and powders of a ceramic material. The powder material of the metal material or the ceramic material may be coated with, for example, a thermoplastic resin shown in the above-described example, or a thermoplastic resin other than those in the above-described example. In this case, the thermoplastic resin may be melted to exhibit fluidity in the plasticization unit 30.

For example, the following solvents may be added to the powder material of the metal material or the ceramic material to be charged into the material supply unit 20 as the material MR. A solvent may be one solvent or a combination of two or more solvents selected from the following solvents.

### Example of Solvent

Water; (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, isopropyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetates (such as tetrabutylammonium acetate); and ionic liquids such as butyl carbitol acetate

In addition, for example, the following binders may be added to the powder material of the metal material or the ceramic material to be charged into the material supply unit 20 as the material MR.

### Example of Binder

Acrylic resin, epoxy resin, silicone resin, cellulose-based resin or other synthetic resins or polylactic acid (PLA), polyamide (PA), polyphenylene sulfide (PPS), polyetheretherketone (PEEK) or other thermoplastic resins

### G. Other Aspects

The present disclosure is not limited to the embodiments described above, and can be implemented in various forms without departing from the scope of the present disclosure. For example, the present disclosure can be implemented in the following aspects. In order to solve apart of or all of problems of the present disclosure, or to achieve a part of or all of effects of the present disclosure, technical features in the above-described embodiments corresponding to technical features in the following aspects can be replaced or combined as appropriate. Further, the technical characteristics can be deleted as appropriate unless the technical characteristics are described as essential in the present specification.

(1) According to a first aspect of the present disclosure, a method of generating three-dimensional shaping data for shaping a three-dimensional shaped object is provided. The method of generating the three-dimensional shaping data includes: a first step of acquiring first shape data representing a shape of the three-dimensional shaped object; a second step of accessing a database storing a plurality of pieces of shape data representing a shape of an object and a plurality of pieces of shaping data generated using the plurality of pieces of shape data in association with each other, and inquiring whether second shape data, which is the shape data corresponding to the first shape data, is stored in the database; and a third step of acquiring or generating the three-dimensional shaping data for shaping the three-dimensional shaped object in accordance with an inquiry result in the second step. In the third step, when the second shape data is stored in the database, second shaping data, which is the shaping data associated with the second shape data, is acquired from the database as the three-dimensional shaping data, or the three-dimensional shaping data is generated using related data related to the second shaping data, and when the second shape data is not stored in the database, first shaping data is generated using the first shape data as the three-dimensional shaping data.

According to the method of generating three-dimensional shaping data in the present aspect, when the second shape data is stored in the database, the second shaping data associated with the second shape data can be acquired from the database and reused as the three-dimensional shaping data for shaping the three-dimensional shaped object represented by the first shape data. Therefore, it is possible to prevent a large amount of time from being taken to generate the three-dimensional shaping data.

(2) In the method of generating three-dimensional shaping data according to the above aspect, when the second shape data is not stored in the database, the first shaping data may be stored in the database in association with the first shape data.

According to the method of generating three-dimensional shaping data in the present aspect, the first shaping data stored in the database can be reused when the three-dimensional shaped object represented by the first shape data is shaped again.

(3) In the method of generating three-dimensional shaping data according to the above-described aspect, when generation data for generating the second shaping data using the second shape data, which is the related data, is stored in the database in association with the second shape data, and a manufacturing condition determined when the second shaping data is generated using the second shape data is different from a manufacturing condition of the three-dimensional shaped object, in the third step, the generation data may be acquired from the database, the generation data may be corrected in accordance with a change content of the manufacturing condition, and the three-dimensional shaping data may be generated using the corrected generation data.

According to the method of generating three-dimensional shaping data in the present aspect, even when the manufacturing condition determined when the second shaping data is generated using the second shape data is different from the manufacturing condition of the three-dimensional shaped object, the generation data acquired from the database can be reused.

(4) In the method of generating three-dimensional shaping data according to the above aspect, the generation data includes corrected shape data obtained by correcting the second shape data. When the generation data is stored in the database in association with the second shape data, and the manufacturing condition determined when the second shaping data is generated using the second shape data is different from the manufacturing condition of the three-dimensional shaped object, in the third step, the corrected shape data may be acquired from the database, the corrected shape data may be corrected in accordance with the change content of the manufacturing condition, and the three-dimensional shaping data may be generated using the corrected shape data after the correction.

According to the method of generating three-dimensional shaping data in the present aspect, even when the manufacturing condition determined when the second shaping data is generated using the second shape data is different from the manufacturing condition of the three-dimensional shaped object, it is possible to easily generate the three-dimensional shaping data for shaping the three-dimensional shaped object.

(5) In the method of generating three-dimensional shaped object according to the above-described aspect, when the generation data includes slice data representing a shape obtained by dividing the shape represented by the second shape data into a plurality of layers, the slice data is stored in the database in association with the second shape data, and the manufacturing condition determined when the second shaping data is generated using the second shape data is the same as the manufacturing condition of the three-dimensional shaped object, in the third step, the slice data may be acquired from the database, and the three-dimensional shaping data may be generated using the slice data.

According to the method of generating three-dimensional shaping data in the present aspect, the three-dimensional shaping data for shaping the three-dimensional shaped object represented by the first shape data can be generated by reusing the slice data acquired from the database.

(6) In the method of generating three-dimensional shaping data generation method according to the above aspect, the database may be accessed from a plurality of three-dimensional shaping devices.

According to the method of generating three-dimensional shaping data in the present aspect, the shape data and the shaping data stored in the database can be used in a plurality of three-dimensional shaping devices.

(7) According to a second aspect of the present disclosure, a method of manufacturing a three-dimensional shaped object is provided. The method of manufacturing a three-dimensional shaped object includes: a first step of acquiring first shape data representing a shape of the three-dimensional shaped object; a second step of accessing a database storing a plurality of pieces of shape data representing a shape of an object and a plurality of pieces of shaping data generated using the plurality of pieces of shape data in association with each other, and inquiring whether second shape data, which is the shape data corresponding to the first shape data, is stored in the database; and a third step of acquiring or generating the three-dimensional shaping data for shaping the three-dimensional shaped object in accordance with an inquiry result in the second step, and a fourth step of shaping the three-dimensional shaped object using the three-dimensional shaping data. In the third step, when the second shape data is stored in the database, second shaping data, which is the shaping data associated with the second shape data, is acquired from the database as the three-dimensional shaping data, or the three-dimensional shaping data is generated using related data related to the second shaping data, and when the second shape data is not stored in the database, first shaping data is generated using the first shape data as the three-dimensional shaping data.

According to the method of manufacturing a three-dimensional shaped object in the present aspect, when the second shape data is stored in the database, the second shaping data associated with the second shape data can be acquired from the database and reused as the three-dimensional shaping data for shaping the three-dimensional shaped object represented by the first shape data. Therefore, it is possible to prevent a large amount of time from being taken to generate the three-dimensional shaping data.

(8) In the method of manufacturing a three-dimensional shaped object according to the above aspect, the database may store the second shaping data and generation data for generating the second shaping data using the second shape data, which is the related data, in association with the second shape data. The method may further include a fifth step of acquiring a degree of difference between a shape of the three-dimensional shaped object shaped in the fourth step and a shape of the three-dimensional shaped object represented by the first shape data, and the generation data and the second shaping data stored in the database may be updated when the degree of difference exceeds an allowable range.

According to the method of manufacturing a three-dimensional shaping object in the present aspect, when the three-dimensional shaped object represented by the first shape data is shaped again, the degree of difference between the shape of the three-dimensional shaped object represented by the first shape data and the shape of the three-dimensional shaped object to be shaped can be reduced.

(9) In the method of manufacturing a three-dimensional shaped object according to the above aspect, the method may further include the fifth step of acquiring the degree of difference between the shape of the three-dimensional shaped object shaped in the fourth step and the shape of the three-dimensional shaped object represented by the first shape data, the first step, the second step, the third step, the fourth step, and the fifth step may be executed a plurality of times using one three-dimensional shaping device, and a timing at which modulation occurs in the three-dimensional shaping device may be predicted using a time series change in the degree of difference.

According to the method of manufacturing a three-dimensional shaped object in the present aspect, it is possible to predict the timing at which the modulation occurs in the three-dimensional shaping device. Therefore, it is possible to prevent shaping of the three-dimensional shaped object with low dimensional accuracy by modulation of the three-dimensional shaping device.

The present disclosure can also be implemented in various forms other than the method of generating the three-dimensional shaping data. For example, the present disclosure can be implemented in the form of a method of manufacturing the three-dimensional shaped object, the three-dimensional shaping device, the three-dimensional shaping system, or the like.

What is claimed is:

1. A method of generating three-dimensional shaping data for shaping a three-dimensional shaped object, the method comprising:
a first step of acquiring first shape data representing a shape of the three-dimensional shaped object;
a second step of accessing a database storing a plurality of pieces of shape data representing a shape of an object and a plurality of pieces of shaping data generated using the plurality of pieces of shape data in association with each other, and inquiring whether second shape data, which is the shape data corresponding to the first shape data, is stored in the database; and
a third step of acquiring or generating three-dimensional shaping data for shaping the three-dimensional shaped object in accordance with an inquiry result in the second step, wherein
in the third step,
when the second shape data is stored in the database, second shaping data, which is the shaping data associated with the second shape data, is acquired from the database as the three-dimensional shaping data, or the three-dimensional shaping data is generated using related data related to the second shaping data, and
when the second shape data is not stored in the database, first shaping data is generated using the first shape data as the three-dimensional shaping data.

2. The method of generating three-dimensional shaping data according to claim 1, wherein
when the second shape data is not stored in the database, the first shaping data is stored in the database in association with the first shape data.

3. The method of generating three-dimensional shaping data according to claim 1, wherein
when generation data for generating the second shaping data using the second shape data, which is the related data, is stored in the database in association with the second shape data, and a manufacturing condition determined when the second shaping data is generated using the second shape data is different from a manufacturing condition of the three-dimensional shaped object, in the third step, the generation data is acquired from the database, the generation data is corrected in accordance with a change content of the manufacturing condition, and the three-dimensional shaping data is generated using the corrected generation data.

4. The method of generating three-dimensional shaping data according to claim 3, wherein
the generation data includes corrected shape data obtained by correcting the second shape data, and
when the generation data is stored in the database in association with the second shape data, and the manufacturing condition determined when the second shaping data is generated using the second shape data is different from the manufacturing condition of the three-dimensional shaped object, in the third step, the corrected shape data is acquired from the database, the corrected shape data is corrected in accordance with the change content of the manufacturing condition, and the three-dimensional shaping data is generated using the corrected shape data after the correction.

5. The method of generating three-dimensional shaping data according to claim 3, wherein
the generation data includes slice data representing a shape obtained by dividing the shape represented by the second shape data into a plurality of layers, and
when the slice data is stored in the database in association with the second shape data, and the manufacturing condition determined when the second shaping data is generated using the second shape data is the same as the manufacturing condition of the three-dimensional shaped object, in the third step, the slice data is acquired from the database, and the three-dimensional shaping data is generated using the slice data.

6. The method of generating three-dimensional shaping data according to claim 1, wherein
the database is accessed from a plurality of three-dimensional shaping devices.

7. A method of manufacturing a three-dimensional shaped object, comprising:
a first step of acquiring first shape data representing a shape of the three-dimensional shaped object;
a second step of accessing a database storing a plurality of pieces of shape data representing a shape of an object and a plurality of pieces of shaping data generated using the plurality of pieces of shape data in association with each other, and inquiring whether second shape data, which is the shape data corresponding to the first shape data, is stored in the database;
a third step of acquiring or generating three-dimensional shaping data for shaping the three-dimensional shaped object in accordance with an inquiry result in the second step; and
a fourth step of shaping the three-dimensional shaped object using the three-dimensional shaping data, wherein
in the third step,
when the second shape data is stored in the database, second shaping data, which is the shaping data associated with the second shape data, is acquired from the database as the three-dimensional shaping data, or the three-dimensional shaping data is generated using related data related to the second shaping data, and
when the second shape data is not stored in the database, first shaping data is generated using the first shape data as the three-dimensional shaping data.

8. The method of manufacturing a three-dimensional shaping object according to claim 7, wherein
the database stores the second shaping data and generation data for generating the second shaping data using the second shape data, which is the related data, in association with the second shape data,
the method further includes a fifth step of acquiring a degree of difference between a shape of the three-dimensional shaped object shaped in the fourth step and a shape of the three-dimensional shaped object represented by the first shape data, and
when the degree of difference exceeds an allowable range, the generation data and the second shaping data stored in the database are updated.

9. The method of manufacturing a three-dimensional shaping object according to claim 7, further comprising:
a fifth step of acquiring a degree of difference between a shape of the three-dimensional shaped object shaped in the fourth step and a shape of the three-dimensional shaped object represented by the first shape data, wherein
the first step, the second step, the third step, the fourth step, and the fifth step are executed a plurality of times by using one three-dimensional shaping device, and
a timing at which modulation occurs in the three-dimensional shaping device is predicted using a time series change in the degree of difference.
